(19) United States
(12) Patent Application Publication
(10) Pub. No.: US 2004/0078126 A1
(43) Pub. Date: Apr. 22, 2004

(54) Control or regulation system

(76) Inventors: Martin Huber, Kornwestheim (DE); Helmar Kuder, Weilerbett (DE); Jochem Spohr, Ehringen (DE)

Correspondence Address: Crowell & Moring LLP, Intellectual Property Group, P O Box 14300, Washington, DC, 20044-4300, US

(21) Appl. No.: 10/433,791

(22) PCT Filed: Nov. 28, 2001
(86) PCT No.: PCT/EP01/13871

(30) Foreign Application Priority Data
Dec. 6, 2000 (DE) 100-60-539.7

(51) Int. Cl. G06F 7/00

(52) U.S. Cl. 701/36

(57) ABSTRACT

A system for controlling or regulating, in particular motor vehicle functions, having at least two control units which are networked to one another via a databus, in which, in order to reduce the power consumption, the system can be placed entirely or only partially in specific power consumption states (1 to 6) in which control units operate with full power consumption (1) or in a power consumption state (2 to 6) in which the power consumption is reduced. At least one control unit has a control program with an interface via which data relating to the power consumption states (1 to 6) for the optimum execution of existing application programs can be transmitted to the control program either by a program within the control unit or by an external request, the control program having means for calculating the necessary power consumption state (1 to 6) for the control unit from the data, and switchover means being provided which, when necessary, change over the control unit from one power consumption state (1 to 6) into a different power consumption state (1 to 6).

The invention relates to a system for controlling or regulating, in particular motor vehicle functions, having at least two control units which are networked to one another via a databus, in which, in order to reduce the power consumption, the system can be placed entirely or only partially in specific states in which control units operate with full power consumption or in a power consumption state in which the power consumption is reduced.

In means of transportation, such networked systems, for example what is referred to as a CAN bus according to ISO 11519 or ISO 11898, are used to control engine functions or comfort functions in the passenger compartment. In the last few years, these databus systems have been specialized even more so that even more specialized databuses are being used for brake by wire systems or for telecommunications such as D2B or MOST databuses. As a result of the high degree of networking, there is now the problem that the vehicle's onboard electrical system is loaded even if the means of transportation is switched off and no control functions, or only a few, are in fact required. In order to reduce the power consumption in the quiescent state, the control units are switched off after a specific time, but it is necessary for the system to be able to receive, for example, a signal from a transponder in order to unlock a door or the like.

DE 197 15 880 C1 discloses a system with control units which are networked via a databus. An individual control unit is provided as a master control unit and is equipped with a standby operating function with wake-up standby, and is continuously active. In the quiescent state of the motor vehicle, the master control unit is in the standby state, while the other control units are switched off. If the master control unit receives a wake-up signal, it wakes up the other control units via a control line so that they are supplied with current again and can be used in their normal function.

DE 196 11 945 C1 discloses a system whose control units stay in an operating state from which they can be returned very quickly into a normal operating state. For this purpose, a semiconductor circuit which can be supplied from a superordinate voltage potential and can be woken up from a sleep mode by means of a control input is connected upstream of each control unit and upstream of its bus protocol module. The wake-up process is carried out by means of a control signal which causes the aforesaid semiconductor circuit to connect through the power supply.

This method is applied especially where it is possible to determine unambiguously which control units can be switched off. However, as the networking increases, it becomes more and more difficult to distribute the application programs among the control units in such a way that the entire control unit can be readily switched off. In distributed systems with a high degree of networking, in which a multiplicity of independent application programs run on a control unit and their result data often has to be made available to application processes in a different control unit, it is not possible to switch off the entire system without previous testing. It is often necessary for specific application processes on various control units also to be able to be executed in the quiescent state of the means of transportation.

Finally, U.S. Pat. No. 5,752,050 discloses a system for controlling the power supply in a personal computer in order to prolong the service life of the accumulator battery of a portable computer. Here, the power consumption can also be controlled by means of peripherals which are connected to the personal computer.

The object of the present invention is to develop a system which is networked by means of a databus in such a way that individual control units and system parts can be placed in a defined power consumption state, it being possible to set the power consumption in a flexible way as a function of the provided application processes on the control units.

This object is achieved by means of the features of claim 1. According to said claim, a plurality of control units are each assigned a control program with an interface via which data relating to the power consumption states for the optimum execution of existing application programs can be transmitted to the control program either by a program within the control unit or by an external request, each control program having means for calculating the necessary power consumption state for the assigned control unit from the data, and wherein switchover means are provided which, when necessary, change over the control unit from one power consumption state into a different power consumption state.

According to the invention it has been recognized that, in distributed systems whose application programs are distributed among various control units in the form of individual modules, the power management program also has to be a program which is distributed among a plurality of control units. Here, the individual power consumption states are determined by means of the requirements within one control unit and are not statically predetermined as in the past. This is necessary as an external preprogrammed power management routine is not suitable with complex distributed software systems on different control units as there is no longer knowledge of the application programs generated by different program manufacturers or as the power management system has to be capable of being adapted in a flexible way to the different application programs on the control units.

In one embodiment, the system of the present invention has a plurality of control units which are networked to one another via a databus. In the example, the databus is what is referred to as a CAN databus via which data of the individual control units can be exchanged. Each control unit has a microcomputer which is responsible for processing the data within the control unit. In addition, data from sensors and data from other control units is processed in the control unit. As a result, data relating to the databus can be output again to other control units or output directly to an actuator, for example an electromotor, in order to trigger, for example, a process during the seat adjustment operation.

In order to convert the data signals from the voltage levels of the microcomputer to the voltage levels in the two-conductor databus, a semiconductor module, for example a CAN transceiver, is necessary, said module converting the voltage level both at the reception and transmission of the data. The data transmission protocol comprises specific additional data such as error detection data and priority data which is added to the data which is to be actually transmitted.

Each control unit is assigned a voltage supply device via which the control unit is supplied with the necessary battery voltage. In addition, each control unit has a clock pulse transmitter which predefines the clock frequency with which the microcomputer operates. The control units preferably have a standard software which provides a type of operating system for each control unit, and one or more application programs or modules which interact with this standard software and make available the processes of the respective applications.

One module of the standard software is what is referred to as a power management module with a control program which controls the power consumption states for at least one control unit. Such a power management module can be provided as a component of the standard software for each individual control unit. The power management module is preferably a software module whose control program is intended to keep the power consumption of the entire system as low as possible. As the application programs in modern means of transportation are distributed among independent, but equally prioritized partial applications, referred to as tasks, it often requires knowledge of the applications running on a control unit to determine when it is possible to change over into a state with lower power consumption.

Application software is often produced by different software developers so that the power consumption control cannot be programmed along with the original application software. Instead, the control of the power consumption can be made dependent on which application programs or which modules are executed on each control unit.

In order to coordinate the power management of the control units with the power consumption demand of the application software which is dependent on the vehicle configuration, a network management algorithm is provided which is configured for transmitting the power management data of the individual control units and in this respect ensures that only the control units which are not required at a given time are connected into a standby mode or are deactivated.

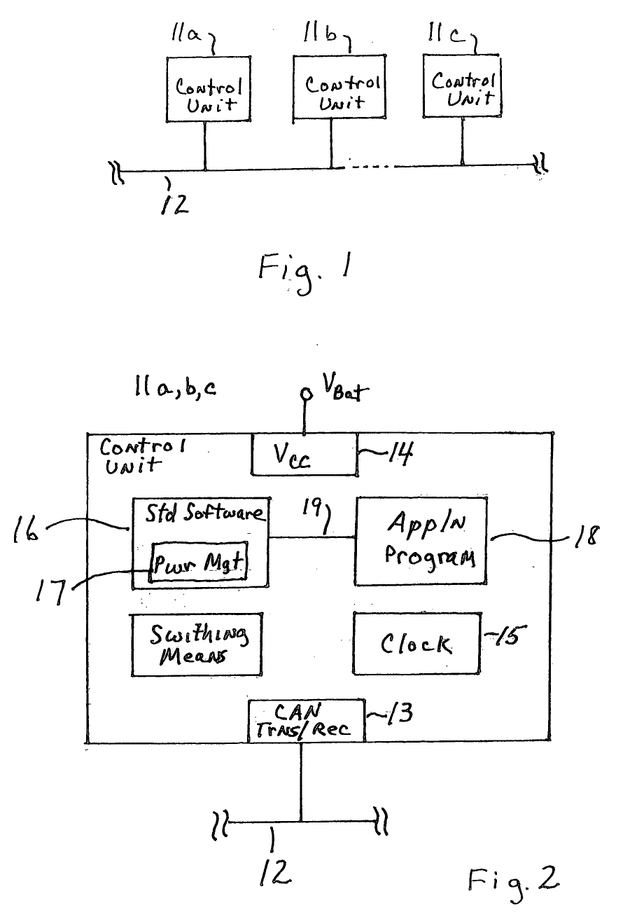

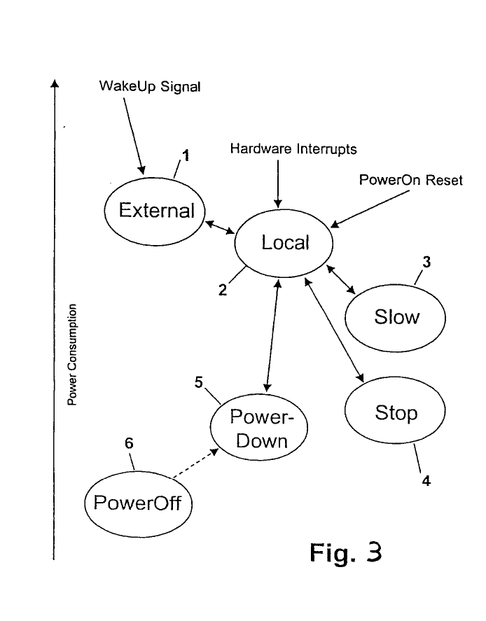

There are various possible ways of advantageously configuring and developing the teaching of the present invention. In this regard, reference is made on the one hand to the subordinate claims and on the other hand to the following explanation of an embodiment. A state diagram for the various power consumption states of the components, in particular of the control units, is illustrated in FIG. 1.

According to the invention, the system provides a control program which can set stepped power consumption states in relation to the power consumption of the system or of the control units. There is provision here for the power management module to be able to assume the following power consumption states: external 1, local 2, slow 3, stop 4, powerdown 5 and poweroff 6.

In the external power consumption state 1, the control unit is supplied with a vehicle battery voltage Vbat, and the electronic voltage level Vcc is provided by means of a voltage regulator which is assigned to the control unit. Here, an external communication, i.e. the transmission of application data via the databus or via a different external control unit interface, is permitted. In this state there are no restrictions on the execution of application programs on the control unit.

In the local power consumption state 2, the control unit is supplied with the vehicle battery voltage Vbat, and the electronic voltage level Vcc is provided. Here, external communication is deactivated. In this state there are no restrictions on the execution of application programs on the control unit insofar as there is no external communication of the application program on the databus or on a control unit interface provided here.

In the slow power consumption state 3, the control unit is supplied with the vehicle battery voltage Vbat, and the electronic voltage level Vcc is provided. In this power consumption state, the processor clock and/or the clock of the data communication is divided down so that the data processing is slowed down on the control unit and/or in the system. In this state, only specific management and application programs which are permitted for slow data processing are preferably executed. In addition, it is possible to provide for only software with a high priority to be executed.

In the stop power consumption state 4 the vehicle battery voltage Vbat is also present at the control unit for the rapid powering up of the system, the voltage supply being switched off in order to provide the electronic voltage level Vcc, and the processor clock being stopped so that basically it is not possible to execute any software any more.

In the powerdown power consumption state 5, the system is supplied neither with the voltage Vcc nor with Vbat so that the power consumption of the system is at a minimum. In the poweroff state 6, the control unit is completely disconnected from the terminals of the power supply.

The system can then be changed from one state into the next by means of the power management software, a sequence controller ensuring that only the power consumption states which are compatible with the system can be assumed by one or more control units. Here, the sequence controller is preferably programmed as a function of the algorithm which is used in the network management system so that, for example, a new power consumption state can be assumed only if the preceding power consumption state is completely terminated in the system. For the sequence control, a programming interface, for example, an interface for connecting an operating computer, is provided so that the sequence control in each control unit can be adapted in a flexible way as a function of the configuration of the entire system, by inputting different parameters.

The power management software constitutes here the conditions which are necessary in the respective control unit, it also being possible to signal the requirement for the changing over from one power consumption state to the next to the microcomputer of the control unit via what are referred to as interrupt signals. For example, a control unit can be woken up from the local state 2 by means of a hardware interrupt which requests an external data transmission. On the other hand, a control unit can be woken up from the slow state 3 or stop state 4 by means of a control input, as a result of which, for example, an external door opening sensor in a motor vehicle indicates that the motor vehicle must reach its full power capability to meet the driver's requirements. On the other hand, the changeover into a different power consumption state can also be requested by a different control unit via the databus. After a specific time without tasks being requested, the power management software if appropriate switches into the lower power consumption state by means of intermediate stages.

What is referred to as an application program interface is provided between the standard software which acts as an operating system and the application software of a control unit. The power management software, as a component of the standard software of the control unit, has here a separate interface with the application software. Via this interface, the instantaneously necessary power consumption states of the control unit in view of the application programs which are running are transmitted and the lowest required power consumption state for the control unit is set. In one embodiment there is provision for the power management software of a plurality of application programs to receive data on the necessary power consumption state via the interface. As each application program transmits the lowest power consumption state which is possible at a given time, the power management software then sets the maximum power consumption state of the power consumption states which are transmitted by the application programs, with the result that the application software can be executed in an optimum way with the minimum power consumption.

The power management software is composed of a plurality of power management modules which can be produced by various programmers. As the power management system has to intervene in the hardware, the power management software is preferably connected to the standard software and has a software interface with the application programs. Before a new changeover into a different power consumption state, the power management software has to check that no further changeover into a different power consumption state is requested, and must if necessary wait until the preceding changeover is completely terminated.

In a different embodiment there is provision for changeovers from a lower to a higher power consumption state to take place without delay so that the system is ready to perform without delays. At changeovers from a higher power consumption state to a lower power consumption state it is possible, according to the invention, for waiting times to be provided in order to avoid having to switch back to a higher power consumption state after a very short time.

The system can have display routines which display the instantaneous set power consumption state via a connected system, for example in a vehicle repair workshop. It is also possible for a power consumption state 1-6 to be provided via an external interface.

1. A system for controlling or regulating, in particular motor vehicle functions, having at least two control units which are networked to one another via a databus, in which, in order to reduce the power consumption, the system can be placed entirely or only partially in specific power consumption states (1 to 6) in which control units operate with full power consumption (1) or in a power consumption state (2 to 6) in which the power consumption is reduced, characterized in that a plurality of control units are each assigned a control program with an interface via which data relating to the power consumption states (1 to 6) for the optimum execution of existing application programs can be transmitted to the control program either by a program within the control unit or by an external request, each control program having means for calculating the necessary power consumption state (1 to 6) for the assigned control unit from the data, and in that switchover means are provided which, when necessary, change over the control unit from one power consumption state (1 to 6) into a different power consumption state (1 to 6).

2. The system as claimed in claim 1, characterized in that the control program provides a hierarchy of power consumption states (1 to 6) which can be set, and, on the basis of the data transmitted to the interface, transmits information to the switchover means in order to set the lowest possible power consumption state (1 to 6) for a control unit.

3. The system as claimed in claim 1 or 2, characterized in that a power consumption state (2) in which external communication via the databus is disabled and a power consumption state (1) in which external communication is permissible can be set by means of the control program.

4. The system as claimed in one of claims 1 to 3, characterized in that the control program can set a power consumption state (3) in which the processor clock of a control unit is reduced in comparison with operation at full load.

5. The system as claimed in one of claims 1 to 4, characterized in that the control program can set a power consumption state (4) in which the battery voltage (Vbat) is applied to the control unit, but the electronic voltage level (Vcc) is switched off.

6. The system as claimed in claim 1, characterized in that the switchover means provide a delay between the request by the data at the interface up to the actual switchover process.

7. The system as claimed in claim 6, characterized in that different delays are provided as a function of the power consumption states which are set or requested.

8. The system as claimed in claim 1, characterized in that a power consumption state (1 to 6) can be predefined for the system and transmitted to the control units via the databus.
